(19) United States
(12) Patent Application Publication
(10) Pub. No.: US 2023/0089665 A1
(43) Pub. Date: Mar. 23, 2023

(54) TOUCH SENSOR FILM

(71) Applicant: FUJIFILM Corporation, Tokyo (JP)

(72) Inventors: Katsuyuki NUKUI, Kanagawa (JP); Tetsuro MITSUI, Kanagawa (JP)

(73) Assignee: FUJIFILM Corporation, Tokyo (JP)

(21) Appl. No.: 17/863,103

(22) Filed: Jul. 12, 2022

(30) Foreign Application Priority Data
Aug. 30, 2021 (JP) 2021-140054
Mar. 23, 2022 (JP) 2022-046384

(51) Int. Cl. G06F 3/041; G06F 3/047

(52) U.S. Cl. CPC G06F 3/04164; G06F 3/047; G06F 2203/04112

(57) ABSTRACT

A touch sensor film includes: a plurality of detection electrodes; and a plurality of lead wires that are electrically connected to the plurality of detection electrodes, in which each of the plurality of detection electrodes has a mesh structure formed of a conductive thin wire, each of the plurality of detection electrodes includes a first connection terminal disposed at an outermost side of each of the plurality of detection electrodes and a second connection terminal disposed by spacing from the first connection terminal, and each of the plurality of lead wires extends up to the second connection terminal through the first connection terminal and electrically connect the first connection terminal and the second connection terminal to each other.

### CROSS-REFERENCE TO RELATED APPLICATIONS

The present application claims priority under 35 U.S.C. § 119 to Japanese Patent Application No. 2021-140054 filed on Aug. 30, 2021, and Japanese Patent Application No. 2022-046384 filed on Mar. 23, 2022. Each of the above application is hereby expressly incorporated by reference, in its entirety, into the present application.

### BACKGROUND OF THE INVENTION

### 1. Field of the Invention

The present invention relates to a touch sensor film.

### 2. Description of the Related Art

Recently, a metal mesh sensor formed of a fine metal wire is adopted as a touch sensor used in a touch panel. The metal mesh sensor has characteristics in that, for example, a touch electrode is formed of a fine metal wire, the resistance is lower than that of a conductive metal oxide (such as indium tin oxide (ITO)), and flexibility is achieved in a case where the metal mesh sensor is formed on a film surface.

The metal mesh sensor has a pattern structure that are mainly connected to a mesh electrode and a lead wire. The mesh electrode is disposed together with an image display unit of a touch panel, and the lead wire is disposed around the image display unit and has a structure extending up to a position (hereinafter referred to as “external connection terminal”) where it is connected to a flexible printed circuit (FPC) connected to an integrated circuit (IC) chip for controlling a touch sensor. Typically, a plurality of lead wires corresponding to the number of mesh electrodes are present, are disposed at intervals of a given or more distance for insulation from adjacent lead wires, and extend up to the external connection terminal as a bundle corresponding to the number of the mesh electrodes. The external connection terminal is connected to a FPC through an anisotropic conductive film (ACF).

An exclusive area of the bundle of the lead wires is determined depending on a line width of the lead wires, the interval between adjacent lead wires, and the number of the lead wires, and the lead wire parts are generally hidden by a decorative printing portion. For the recent touch panel, design is required, and thus it is desired to reduce the area of the decorative printing portion and to widen the area of the image display unit in the touch panel (also referred to as “frame narrowing”. That is, it is required to reduce the area of the decorative printing portion. To that end, for example, it is to reduce the area of the bundle of the lead wires. As a method corresponding to frame narrowing, for example, a method of reducing the line width of the lead wires and a method of reducing the interval between adjacent lead wires are adopted (also referred to as “L/S down”).

In a case where the line width of the lead wires is reduced, in order to reliably drive the touch sensor, it is necessary to electrically connect a detection electrode and the lead wire with reliability. Therefore, for example, JP2015-45890A discloses a structure where a lead wire and a detection electrode are not likely to be disconnected. In JP2015-45890A, assuming that any wire in a fine wire portion of a connection region is disconnected without being drawn, a method of increasing a line width in the connection region is disclosed.

### SUMMARY OF THE INVENTION

As frame narrowing progresses, the pattern density of a lead wire part increases. Due to this effect, during roll-to-roll production or during extraction of a touch sensor in a state where touch sensor films are laminated in a sheet size, peeling charging and a spark current occur in the lead wire part. In this case, due to the effect of a current flowing from the lead wire, a part of a mesh-like conductive electrode pattern connected to the lead wire part may break (referred to as spark failure). In a case where the spark failure causes one of a plurality of conductive electrodes in each of touch sensors such that conduction failure occurs, In a case where the touch sensor film does not satisfy a function as a touch sensor and becomes a defective product. In addition, in a case where the conduction failure does not occur due to spark failure but spark failure occurs in a portion of a visible region of a touch panel, the appearance of a mesh fine wire at a defect position is different such that this defect is recognized as a surface defect.

In the technique described in JP2015-45890A, connection failure between a detection electrode and a lead wire part caused by drawing failure can be improved. However, the effect of improving spark failure is not achieved.

The present invention has been made in order to solve the problem, and an object thereof is to provide a touch sensor film in which spark resistance is improved during manufacturing of the touch sensor film.

A touch sensor film comprises:

a plurality of detection electrodes; and

a plurality of lead wires that are electrically connected to the plurality of detection electrodes,

in which each of the plurality of detection electrodes has a mesh structure formed of a conductive thin wire,

each of the plurality of detection electrodes includes a first connection terminal disposed at an outermost side of each of the plurality of detection electrodes and a second connection terminal disposed by spacing from the first connection terminal, and

each of the plurality of lead wires extends up to the second connection terminal through the first connection terminal and electrically connect the first connection terminal and the second connection terminal to each other.

Line widths of the first connection terminal and the second connection terminal may be the same as a line width of the conductive thin wire.

Each of the plurality of detection electrodes may further include a third connection terminal that is electrically connected to each of the plurality of lead wires, and

the first connection terminal, the second connection terminal, and the third connection terminal may be disposed in this order.

A length of any one of the first connection terminal or the second connection terminal may be more than an electrode width of each of the plurality of detection electrodes.

In addition, an interval between the at least two connection terminals may be 5 μm or more.

According to the aspect of the present invention, the touch sensor film comprises: a substrate; detection electrodes that are disposed on the substrate and have a mesh structure formed of a conductive thin wire; lead wires that are disposed around the detection electrodes on the substrate; and connection terminals that connect the lead wires and the detection electrodes, in which the connection terminals include a connection terminal 1, a connection terminal 2, . . . , and a connection terminal n, the connection terminal 1 is disposed at an end part of the detection electrode, and the lead wire extends up to and is connected to the connection terminal n through the connection terminal 1. As a result, spark failure of the touch sensor film can be suppressed.

### BRIEF DESCRIPTION OF THE DRAWINGS

FIG. 1 is a partial cross-sectional view showing a film according to Embodiment 1 of the present invention.

FIG. 2 is a plan view showing the film according to Embodiment 1 of the present invention.

FIG. 3 is a enlarged plan view showing a connecting part between a lead wire and a detection electrode and a connection terminal in a general touch sensor film.

FIG. 4 is a enlarged plan view showing a connecting part between a lead wire and a first detection electrode and a connection terminal in a touch sensor film according to Embodiment 1 of the present invention.

FIG. 5 is a enlarged plan view showing a connecting part between a lead wire and a first detection electrode and a connection terminal in a touch sensor film according to Embodiment 2 of the present invention.

FIG. 6 is a enlarged plan view showing a connecting part between a lead wire and a first detection electrode and a connection terminal in a touch sensor film according to Embodiment 3 of the present invention.

FIG. 7 is a enlarged plan view showing a connecting part between a lead wire and a first detection electrode and a connection terminal in a touch sensor film according to Embodiment 4 of the present invention.

FIG. 8 is a enlarged plan view showing a connecting part between a lead wire and a first detection electrode and a connection terminal in a touch sensor film according to Embodiment 5 of the present invention.

### DESCRIPTION OF THE PREFERRED EMBODIMENTS

Hereinafter, a conductive member for a touch panel according to the present invention will be described in detail based on a preferable embodiment shown in the accompanying drawings.

In the following description, a numerical range indicated by the expression “to” includes numerical values described on both sides. For example, in a case where “s is a numerical value t1 to a numerical value t2”, the range s is a range including the numerical value t1 and the numerical value t2, which is expressed by a mathematical symbol t1≤s≤t2.

Unless specified otherwise, the meaning of an angle such as “perpendicular” or “parallel” includes a case where an error range is generally allowable in the technical field.

“Transparent” represents that a light transmittance in a visible wavelength range of 400 to 800 nm is at least 40% or more, preferably 75% or more, more preferably 80% or more, and still more preferably 90% or more. The light transmittance is measured using “Plastics—Determination of Total Luminous Transmittance And Reflectance” defined by Japanese Industrial Standards (JIS) K 7375:2008.

### Embodiment 1

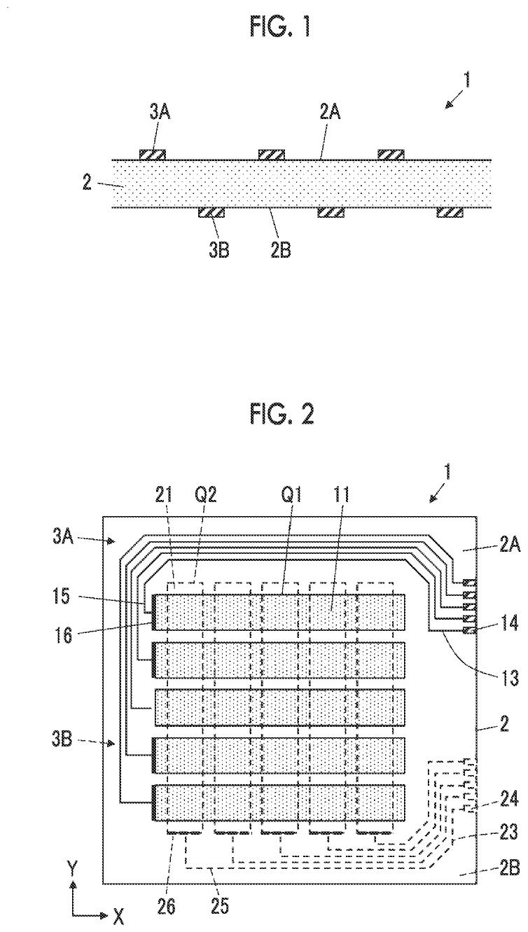

FIG. 1 shows a configuration of a touch sensor film 1 according to Embodiment 1 of the present invention.

The film 1 includes: a substrate 2 that is transparent and has insulating properties; a first conductive layer 3A that is disposed on a first surface 2A of the substrate 2; and a second conductive layer 3B that is disposed on a second surface 2B of the substrate 2.

As shown in FIG. 2, the substrate 2 includes a plurality of first electrode regions Q1 that extend in a given direction and are arranged in a direction perpendicular to the given direction on the first surface 2A.

The first conductive layer 3A that is disposed on the first surface 2A of the substrate 2 includes: a plurality of first detection electrodes 11 that are disposed on the plurality of first electrode regions Q1, respectively, and extend in the same direction as a direction in which the first electrode regions Q1 extend; a plurality of first lead wires 13 that are disposed around the plurality of first detection electrodes 11 and have a number corresponding to the number of the plurality of first detection electrodes 11; and a plurality of first external connection terminals 14 that are electrically connected to the plurality of first lead wires 13. The plurality of first detection electrodes 11, the plurality of first lead wires 13, and the plurality of first external connection terminals 14 have the same composition as each other. The plurality of first detection electrodes 11, the plurality of first lead wires 13, and the plurality of first external connection terminals 14 are formed at the same time. The formation at the same time refers to formation in the same step.

Here, for convenience of description, a given direction in which the plurality of first detection electrodes 11 extend will be referred to as “X direction”, an arrangement direction of the plurality of first detection electrodes 11 perpendicular to the X direction will be referred to as “Y direction”, and a thickness direction of the plurality of first detection electrodes 11 perpendicular to the X direction and the Y direction will be referred to as “Z direction”.

One end part of each of the plurality of first lead wires 13 is disposed near an end part of the corresponding first detection electrode 11 on one side in the X direction, and another end part of each of the plurality of first lead wires 13 is connected to the first external connection terminal 14. One end part of the first lead wire 13 that is disposed near the first detection electrode 11 includes: a wiring part 15 that is disposed around the first detection electrode 11 and has one end part connected to the first external connection terminal 14; and a connection terminal 16 that is connected to another end part of the wiring part 15 and extends in the Y direction.

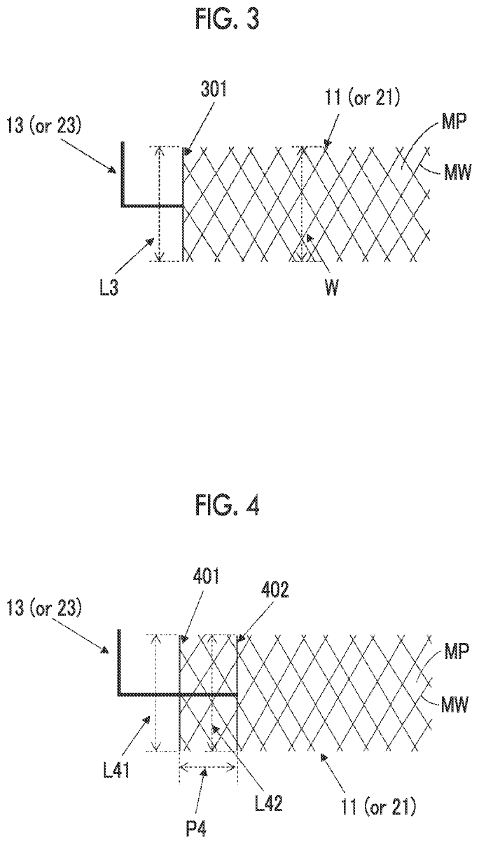

As shown in FIG. 3, the connection terminal 16 and the first detection electrode 11 are generally connected to each other in the X direction irrespective of the present invention.

In addition, the first detection electrode 11 is formed of a plurality of fine metal wires MW formed in the first electrode region Q1, and a rhombic mesh-like pattern MP is formed by the plurality of fine metal wires MW. The fine metal wire MW is an example of the conductive thin wire. The rhombic mesh-like pattern MP, that is, the mesh structure consists of a conductive thin wire.

Incidentally, typically, the touch sensor film is designed in many cases such that the first detection electrode, the first lead wire, the connection terminal, and the first external connection terminal are electrically connected to each other, for example, by connecting the first lead wire, the first detection electrode, the connection terminal, and the first external connection terminal to each other. In addition, typically, in order to reduce the number of manufacturing steps, the first detection electrode, the first peripheral wire, and the first external connection terminal that are electrically connected to each other are formed at the same time in many cases.

The touch sensor film in the related art that is manufactured as described above may be laminated on another touch sensor film, for example, in a winding step of a so-called roll-to-roll method. In a case where the touch sensor films are peeled off in this state, a first conductive layer of the peeled touch sensor film may be charged such that a potential difference is generated in the first conductive layer. In a case where spark is generated in the first conductive layer due to this potential difference, there may be a failure in that a conductive pattern including a plurality of first detection electrodes, a plurality of first lead wires, a plurality of connection terminals, and a plurality of first external connection terminals forming the first conductive layer.

In this case, in a case where the area of a connecting part between the connection terminal and the lead wire or between the connection terminal and the detection electrode is small, spark failure is likely to occur in this portion. The reason for this is presumed to be that, since the area of the connecting part is small, a current generated by peeling charging is likely to concentrate on the same portion such that the portion is heated and break.

The touch sensor film 1 according to Embodiment 1 of the present invention has a configuration of FIG. 4. In FIG. 4, the detection electrode and the lead wire are electrically connected to include a portion connected to both of a first connection terminal 401 and a second connection terminal 402. The first connection terminal 401 is disposed at an end part of the detection electrode, that is, the first connection terminal 401 is disposed at a position closest to the lead wire, and the lead wire extends up to and is connected to the second connection terminal 402 through the first connection terminal 401. In the embodiment of the present invention, the area of connecting parts of the lead wire, the detection electrode, and the connection terminal increases, and the area of portions where a current concentrates decreases. Therefore, spark resistance is improved. As a result, spark failure of the touch sensor film can be suppressed.

The first connection terminal 401 and the second connection terminal 402 are spaced from each other at an interval P4. The interval P4 may be large or small. However, in a case where the interval P4 is excessively large, the thickness of a frame portion increases, which is not preferable. The size of the interval P4 is preferably 500 μm or less, more preferably 100 μm or less, and still more preferably 20 μm or less.

A length L41 of the first connection terminal 401 and a length L42 of the second connection terminal 402 may be the same as or different from each other. In addition, the length L41 of the first connection terminal 401 and the length L42 of the second connection terminal 402 may be the same, longer than, or shorter than a width W (refer to FIG. 3) of the detection electrode.

In addition, it is preferable line widths of the first connection terminal 401 and the second connection terminal 402 are the same as a line width of the conductive thin wire, for example, a line width of the fine metal wire MW. As a result, the conduction failure incidence ratio further decreases. That is, the spark failure incidence ratio further decreases.

In addition, as shown in FIG. 2, the substrate 2 includes a plurality of second electrode regions Q2 that extend in the Y direction and are arranged in the X direction on the second surface 2B.

The second conductive layer 3B disposed on the second surface 2B of the substrate 2 includes: a plurality of second detection electrodes 21 that are disposed in the plurality of second electrode regions Q2, respectively, and extend in the Y direction; a plurality of second lead wires 23 that are disposed around the plurality of second detection electrodes 21 and have a number corresponding to the number of the plurality of second detection electrodes 21; and a plurality of second external connection terminals 24 that are electrically connected to the plurality of second lead wires 23. The plurality of second detection electrodes 21, the plurality of second lead wires 23, and the plurality of second external connection terminals 24 have the same composition as each other. The plurality of second detection electrodes 21, the plurality of second lead wires 23, and the plurality of second external connection terminals 24 are formed at the same time.

One end part of each of the plurality of second lead wires 23 is disposed near an end part of the corresponding second detection electrode 21 on one side in the Y direction, and another end part of each of the plurality of second lead wire 23 is connected to the second external connection terminal 24. One end part of the second lead wire 23 that is disposed near the second detection electrode 21 includes: a wiring part 25 that is disposed around the second detection electrode 21 and has one end part connected to the second external connection terminal 24; and a terminal part 26 that is connected to another end part of the wiring part 25 and extends in the X direction. The terminal part 26 and the second detection electrode 21 are connected to each other in the Y direction. Therefore, the second detection electrode 21 and the second lead wire 23 are electrically connected to each other.

In this case, likewise, the lead wire, the connection terminal, and the detection electrode disposed on the second surface have the configuration of FIG. 4. In this case, the effect is the same as the effect on the first surface.

In addition, although not shown in the drawing, the second detection electrode 21 is formed of a plurality of fine metal wires MW formed in the second electrode region Q2, and a mesh-like pattern MP is formed by the plurality of fine metal wires MW as in the first detection electrode 11.

The line widths of the plurality of fine metal wires MW forming the first detection electrode 11 and the plurality of fine metal wires MW forming the second detection electrode 21 are set in a range of preferably 0.5 μm or more and 10.0 μm or less, more preferably 1.0 μm or more and 5.0 μm or less, and still more preferably 1.5 μm or more and 3.0 μm or less so as to make the fine metal wires inconspicuous to an observer, that is, to secure visibility.

Line widths of the plurality of fine metal wires MW forming the first detection electrode 11 are measured from a planar image including the fine metal wires MW of the touch sensor film acquired with a scanning electron microscope (SEM). In the planar image, any five portions corresponding to the line width of one fine metal wire MW are selected, and an arithmetic mean value of the line widths of the five portions is obtained as the line width.

Line widths of the plurality of fine metal wires MW forming the second detection electrode 21 are measured from a planar image including the fine metal wires MW of the touch sensor film acquired with a scanning electron microscope (SEM). In the planar image, any five portions corresponding to the line width of one fine metal wire MW are selected, and an arithmetic mean value of the line widths of the five portions is obtained as the line width.

In addition, in order to secure sufficient conductivity, the line widths of the first lead wires 13 and the second lead wires 23 are set in a range of preferably 2.0 μm or more and 100 μm or less and more preferably 3.0 μm or more and 20 μm or less.

The line width of the first lead wire 13 is measured from a planar image including the first lead wire 13 of the touch sensor film acquired with a scanning electron microscope (SEM). In the planar image, any five portions corresponding to the line width of one first lead wire 13 are selected, and an arithmetic mean value of the line widths of the five portions is obtained as the line width.

The line width of the second lead wire 23 is measured from a planar image including the second lead wire 23 of the touch sensor film acquired with a scanning electron microscope (SEM). In the planar image, any five portions corresponding to the line width of one second lead wire 23 are selected, and an arithmetic mean value of the line widths of the five portions is obtained as the line width.

In addition, from the viewpoint of preventing a failure such as disconnection in a case where the film 1 is folded and the viewpoint of obtaining sufficient conductivity, the thicknesses of the first detection electrode 11 and the first lead wire 13 and the thicknesses of the second detection electrode 21 and the second lead wire 23 are preferably 0.01 μm to 10.0 μm, more preferably 0.05 μm to 5.0 μm, and still more preferably 0.10 μm to 2.5 μm.

The thicknesses of the first detection electrode 11 and the first lead wire 13 and the thicknesses of the second detection electrode 21 and the second lead wire 23 are measured from a cross-sectional image including a cut cross section of the touch sensor film acquired with a scanning electron microscope (SEM). In the cross-sectional image, any five portions corresponding to each of the thicknesses of the first detection electrode 11 and the first lead wire 13 and the thicknesses of the second detection electrode 21 and the second lead wire 23 are selected, and an arithmetic mean value of the portions corresponding to the five thicknesses is obtained as the thickness.

In addition, each of the interval P4, an interval P51, an interval P52, and intervals P60-1 to P60-(n−1) is measured from a planar image including the interval P4, the interval P51, the interval P52, or the intervals P60-1 to P60-(n−1) of the touch sensor film that is acquired with a scanning electron microscope (SEM). In the planar image, any five portions corresponding to each of the interval P4, the interval P51, the interval P52, and the intervals P60- to P60-(n−1) are selected, and an arithmetic mean value of the portions corresponding to the intervals of the five portions is obtained as each of the interval P4, the interval P51, the interval P52, and the intervals P60-1 to P60-(n−1). The distance between the centers of a pair of connection terminals forming each of the intervals in the line width direction refers to the interval.

In addition, in the film 1, the first conductive layer 3A is disposed on the first surface 2A of the substrate 2, and the second conductive layer 3B is disposed on the second surface 2B of the substrate 2. However, the film 1 may include only any one of the first conductive layer 3A or the second conductive layer 3B. Even in this case, as in a case where the film 1 includes both of the first conductive layer 3A and the second conductive layer 3B, the generation of spark in the first conductive layer 3A or in the second conductive layer 3B can be suppressed, and failure of the film 1 can be suppressed.

In addition, in the above description, the first detection electrode 11 and the second detection electrode 21 have the rhombic mesh-like pattern MP. The shape of an opening of the mesh is not limited to a rhombic shape and may be a regular triangular shape, a regular quadrangular shape, a regular hexagonal shape, other regular polygonal shapes, or a polygonal shape having a random shape or may be a shape having a curve.

In addition, in FIG. 2, the first electrode region Q1 and the second electrode region Q2 have a rectangular shape. As long as a touch operation can be detected by the first detection electrode 11 and the second detection electrode 21, the shape of the first electrode region Q1 and the shape of the second electrode region Q2 are not particularly limited.

### Embodiment 2

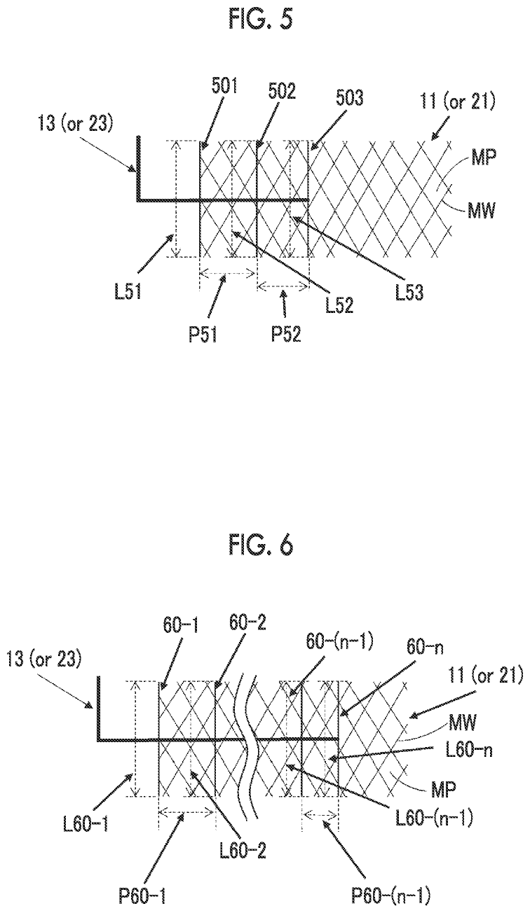

The touch sensor film 1 according to Embodiment 2 of the present invention has a configuration of FIG. 5. In FIG. 5, the detection electrode and the lead wire are electrically connected to include a portion connected to both of a first connection terminal 501, a second connection terminal 502, and a third connection terminal 503. The first connection terminal 501 is disposed at an end part of the detection electrode, and the lead wire extends up to and is connected to the third connection terminal 503 through the first connection terminal 501, the second connection terminal 502, and the third connection terminal 503. In the embodiment of the present invention, the area of connecting parts of the lead wire, the detection electrode, and the connection terminal increases, and the area of portions where a current concentrates decreases. Therefore, spark resistance is improved. As a result, spark failure of the touch sensor film can be suppressed.

The first connection terminal 501 and the second connection terminal 502 are spaced from each other at the interval P51, and the second connection terminal 502 and the third connection terminal 503 are spaced from each other at the interval P52. The interval P51 and the interval P52 may be large or small. However, in a case where the interval P51 and the interval P52 are excessively large, the thickness of a frame portion increases. The interval P51 and the interval P52 are preferably 250 μm or less, more preferably 50 μm or less, and still more preferably 20 μm or less. The sizes of the interval P51 and the interval P52 may be the same as or different from each other.

A length L51 of the first connection terminal 501, a length L52 of the second connection terminal 502, and a length L53 of the third connection terminal 503 may be the same as or different from each other. In addition, the length L51 of the first connection terminal 501, the length L52 of the second connection terminal 502, and the length L53 of the third connection terminal 503 may be the same, longer than, or shorter than the width W (refer to FIG. 3) of the detection electrode.

In this case, the lead wire, the connection terminal, and the detection electrode on the second surface also have the configuration of FIG. 5. In this case, the effect is the same as the effect on the first surface.

### Embodiment 3

The touch sensor film 1 according to Embodiment 3 of the present invention has a configuration of FIG. 6. In FIG. 6, the detection electrode and the lead wire are electrically connected to include a portion connected to each of n connection terminals including a first connection terminal 60-1 to an N-th connection terminal 60-n. The first connection terminal 60-1 is disposed at an end part of the detection electrode, and the lead wire extends up to and is connected to the N-th connection terminal 60-n through the first connection terminal 60-1 to the N-th connection terminal 60-n. In the embodiment of the present invention, the area of connecting parts of the lead wire, the detection electrode, and the connection terminal increases, and the area of portions where a current concentrates decreases. Therefore, spark resistance is improved. As a result, spark failure of the touch sensor film can be suppressed.

The first connection terminal 60-1 to the N-th connection terminal 60-n are distant from each other at intervals P60-1 to 60-(n−1), respectively. The intervals P60-1 to P60-(n−1) may be large or small. However, in a case where the intervals P60-1 to P60-(n−1) are excessively large, the thickness of a frame portion increases. The intervals P60-1 to P60-(n−1) are preferably 500 μm or less, more preferably 20 μm or less, and still more preferably 5 μm or less.

Lengths L60-1 to L60-n of the first connection terminal 60-1 to the N-th connection terminal 60-n may be the same as or different from each other. In addition, the lengths L60-1 to L60-n of the first connection terminal 60-1 to the N-th connection terminal 60-n may be the same, longer than, or shorter than the width W (refer to FIG. 3) of the detection electrode.

In this case, the lead wire, the connection terminal, and the detection electrode on the second surface also have the configuration of FIG. 6. In this case, the effect is the same as the effect on the first surface.

In Embodiment 3, a case where n=1 corresponds to Embodiment 1, and a case where n=3 corresponds to Embodiment 2.

The configuration of the lead wire, the connection terminal, and the detection electrode on the first surface and the configuration of the lead wire, the connection terminal, and the detection electrode on the second surface may have the same structure or different structures. In addition, the configuration of the lead wire, the connection terminal, and the detection electrode on each of the surfaces may vary depending on a plurality of detection electrodes and a plurality of lead wires. That is, the configurations of the lead wire, the connection terminal, and the detection electrode described in Embodiments 1 to 3 can be freely adopted in each of the connecting parts between the detection electrodes and the lead wires.

The line widths of the first connection terminal 60-1 to the N-th connection terminal 60-n are not particularly limited. In a case where the line widths are excessively small, disconnection is likely to occur. However, in a case where the line widths are excessively large, the thickness of a frame portion increases. The line widths of the first connection terminal 60-1 to the N-th connection terminal 60-n are preferably 1 μm to 50 μm and more preferably 1.5 μm to 20 μm. The first connection terminal 60-1 to the N-th connection terminal 60-n may have the same width or different widths.

The thicknesses of the first connection terminal 60-1 to the N-th connection terminal 60-n are not particularly limited. In a case where the thicknesses are excessively small, disconnection is likely to occur. In a case where the thicknesses are excessively large, breakage is likely to occur during handling. The thicknesses of the first connection terminal 60-1 to the N-th connection terminal 60-n are preferably 0.1 μm to 10 μm and more preferably 0.5 μm to 3 μm. The thicknesses of the first connection terminal 60-1 to the N-th connection terminal 60-n may have the same width or different widths.

### Embodiment 4

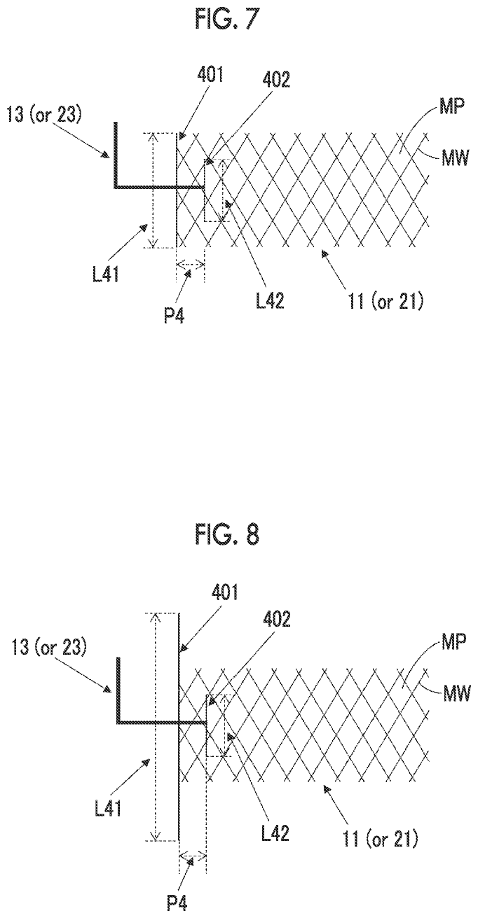

The touch sensor film 1 according to Embodiment 4 of the present invention has a configuration of FIG. 7. Embodiment 4 of the present invention is a modification example of Embodiment 1 shown in FIG. 4. Therefore, the same structures in those of the configuration shown in FIG. 4 are represented by the same reference numerals, and the detailed description thereof will not be repeated.

In FIG. 7, the length L41 of the first connection terminal 401 is the same as the width W (refer to FIG. 3) of the detection electrode, and the length L42 of the second connection terminal 402 is shorter than the width W (refer to FIG. 3) of the detection electrode.

In the embodiment of the present invention, the area of connecting parts of the lead wire, the detection electrode, and the connection terminal increases, and the area of portions where a current concentrates decreases. Therefore, spark resistance is improved. As a result, spark failure of the touch sensor film can be suppressed.

### Embodiment 5

The touch sensor film 1 according to Embodiment 5 of the present invention has a configuration of FIG. 8. Embodiment 5 of the present invention is a modification example of Embodiment 1 shown in FIG. 4. Therefore, the same structures in those of the configuration shown in FIG. 4 are represented by the same reference numerals, and the detailed description thereof will not be repeated.

In FIG. 8, the length L41 of the first connection terminal 401 is longer than the width W (refer to FIG. 3) of the detection electrode, and the length L42 of the second connection terminal 402 is shorter than the width W (refer to FIG. 3) of the detection electrode.

In the embodiment of the present invention, the area of connecting parts of the lead wire, the detection electrode, and the connection terminal increases, and the area of portions where a current concentrates decreases. Therefore, spark resistance is improved. As a result, spark failure of the touch sensor film can be suppressed.

All of the first connection terminal 401, the second connection terminal 402, the first connection terminal 501, the second connection terminal 502, the third connection terminal 503, and the first connection terminal 60-1 to the N-th connection terminal 60-n are linear conductive thin wires, for example, fine metal wires and are different from the fine metal wires MW forming the rhombic mesh-like pattern MP.

As long as the first connection terminal 401, the second connection terminal 402, the first connection terminal 501, the second connection terminal 502, the third connection terminal 503, and the first connection terminal 60-1 to the N-th connection terminal 60-n are disposed on the first detection electrode 11, they are linear fine metal wires extending in a direction perpendicular to a direction in which the first detection electrode 11 extends.

In addition, as long as the first connection terminal 401, the second connection terminal 402, the first connection terminal 501, the second connection terminal 502, the third connection terminal 503, and the first connection terminal 60-1 to the N-th connection terminal 60-n are disposed on the second detection electrode 21, they are linear fine metal wires extending in a direction perpendicular to a direction in which the second detection electrode 21 extends.

In addition, in a case where the number of the connection terminals that are provided is excessively large, the thickness of a frame portion increases, which is not preferable. The number is preferably 3 or less.

In the first connection terminal 401, the second connection terminal 402, the first connection terminal 501, the second connection terminal 502, the third connection terminal 503, and the first connection terminal 60-1 to the N-th connection terminal 60-n, the spark failure incidence ratio further decreases. Therefore, it is preferable that an interval between at least two or more connection terminals is 5 μm or more. The reason for this is presumed to be that, by increasing the distance between contact portions where peeling charging ma occur, the current density generated by peeling charging can be reduced.

Hereinafter, each of the members forming the touch sensor film 1 according to Embodiment 1 will be described. It is assumed that the description of each of the members forming the touch sensor films according to Embodiments 2 to 5 conforms to that of each of the members forming the touch sensor film 1 according to Embodiment 1.

Substrate

The substrate 2 is not particularly limited as long as it is transparent, has electric insulating characteristics, and supports the first conductive layer 3A and the second conductive layer 3B. For example, a resin substrate or a glass substrate is used. More specifically, as a material for forming the substrate 2, for example, glass, reinforced glass, non-alkali glass, polyethylene terephthalate (PET), polyethylene naphthalate (PEN), a cyclo-olefin polymer (COP), a cyclic olefin copolymer (COC), polycarbonate (PC), an acrylic resin, polyethylene (PE), polypropylene (PP), polystyrene (PS), polyvinyl chloride (PVC), polyvinylidene chloride (PVDC), or cellulose triacetate (TAC) can be used. The thickness of a transparent insulating substrate 5 is, for example, preferably 20 μm to 1100 μm and more preferably 20 μm to 500 μm. In particular, in a case where an organic resin substrate such as PET is used, the thickness is preferably 20 μm to 200 μm and more preferably 30 μm to 100 μm.

The total light transmittance of the substrate 2 is preferably 40% to 100%. The total light transmittance is measured using “Plastics—Determination of Total Luminous Transmittance And Reflectance” defined by JIS K 7375:2008.

Examples of a preferable aspect of the substrate 2 include a treated substrate that undergoes at least one treatment selected from the group consisting of an atmospheric pressure plasma treatment, a corona discharge treatment, and an ultraviolet irradiation treatment. By performing the above-described treatment, a hydrophilic group such as an OH group is introduced into the treated surface of the transparent insulating substrate 5. As a result, the adhesiveness between the substrate 2 and the first conductive layer 3A and the adhesiveness between the substrate 2 and the second conductive layer 3B are improved. In addition, the atmospheric pressure plasma treatment is preferable among the above-described treatments from the viewpoint of further improving the adhesiveness between the substrate 2 and the first conductive layer 3A and the adhesiveness between the substrate 2 and the second conductive layer 3B.

Undercoat Layer

In order to improve the adhesiveness between the substrate 2 and the first conductive layer 3A and the adhesiveness between the substrate 2 and the second conductive layer 3B, an undercoat layer can also be disposed between the substrate 2 and the first conductive layer 3A and between the substrate 2 and the second conductive layer 3B. This undercoat layer includes a polymer such that the adhesiveness between the substrate 2 and the first conductive layer 3A and the adhesiveness between the substrate 2 and the second conductive layer 3B are further improved.

A method of forming the undercoat layer is not particularly limited, and examples thereof include a method of applying a composition for forming an undercoat layer including a polymer to the substrate and optionally performing a heat treatment thereon. In addition, as a composition for forming an undercoat layer including a polymer, for example, gelatin, an acrylic resin, a urethane resin, or an acrylic styrene latex including fine particles of an inorganic material or a polymer may be used.

Optionally, in the film 1, as a layer other than the above-described undercoat layer, a refractive index adjusting layer may be provided between the substrate 2 and the first conductive layer 3A and between the substrate 2 and the second conductive layer 3B. As the refractive index adjusting layer, for example, an organic layer to which particles of a metal oxide such as zirconium oxide for adjusting a refractive index can be used.

Conductive Layer and Connecting Part

The first conductive layer 3A including the plurality of first detection electrodes 11, the plurality of first lead wires 13, and the plurality of first external connection terminals 14 and the second conductive layer 3B including the plurality of second detection electrodes 21, the plurality of second lead wires 23, and the plurality of second external connection terminals 24 can be formed of a metal or an alloy as a conductive material, for example, copper, aluminum, or silver. The alloy may include, for example, gold, silver, or copper. In addition, the first conductive layer 3A, the second conductive layer 3B, and a connecting part may include metallic silver, gelatin, or a polymer binder such as an acrylic styrene latex. Other preferable examples of the material include a metal and an alloy of aluminum, silver, molybdenum, and titanium. In addition, a laminated structure of the materials may be used. For example, a laminated structure such as molybdenum/copper/molybdenum or molybdenum/aluminum/molybdenum can be used. In addition, the first conductive layer 3A and the second conductive layer 3B may include metal oxide particles, a metal paste such as a silver paste or a copper paste, or metal nanowire particles such as silver nanowire or copper nanowire.

In addition, in order to improve the visibility of the fine metal wires MW forming the first detection electrode 11 and the second detection electrode 21, a blackening layer may be formed on surfaces of the fine metal wires MW that are recognized by an observer. As the blackening layer, a metal oxide, a metal nitride, a metal oxynitride, or a metal sulfide can be used. Representatively, for example, copper oxynitride, copper nitride, copper oxide, or molybdenum oxide can be used.

Next, a method of forming the first conductive layer 3A and the second conductive layer 3B will be described. As the first conductive layer 3A and the second conductive layer 3B, for example, a sputtering method, a plating method, a silver halide method, or a printing method can be appropriately used.

A method of forming the first conductive layer 3A and the second conductive layer 3B using a sputtering method will be described. First, by forming a layer of a conductive material by sputtering and forming a wiring line using the layer of the conductive material by photolithography, the first conductive layer 3A and the second conductive layer 3B can be formed. The layer of the conductive material can also be formed by so-called vapor deposition instead of sputtering. As the layer of the conductive material, an electrolytic metal foil can be used in addition sputtering or vapor deposition. More specifically, a step of forming a copper wiring line described in JP2014-29614A can be used.

A method of forming the first conductive layer 3A and the second conductive layer 3B using a plating method will be described. For example, the first conductive layer 3A and the second conductive layer 3B can be formed using a metal plating film that is formed on an electroless plating underlayer by performing electroless plating on the underlayer. In this case, the first conductive layer 3A and the second conductive layer 3B are formed by forming a catalyst ink including at least metal fine particles on a substrate in a patterned manner and dipping the substrate in an electroless plating bath to form a metal plating film. More specifically, a method of manufacturing a metal-coated substrate described in JP2014-159620A can be used.

In addition, the first conductive layer 3A and the second conductive layer 3B are formed by forming a resin composition having at least a functional group capable of interacting a metal catalyst precursor on a substrate in a patterned manner, adding a catalyst or catalyst precursor, and dipping the substrate in an electroless plating bath to form a metal plating film. More specifically, a method of manufacturing a metal-coated substrate described in JP2012-144761A can be used. In addition, the first conductive layer 3A and the second conductive layer 3B may be formed by performing electroless plating on a wiring pattern that is formed using a silver halide method. In this case, the first conductive layer 3A and the second conductive layer 3B are formed by forming a pattern formed of silver particles through steps including steps of exposing and developing a film to which a photographic sensitive material is applied and optionally including a gelatin removal step and performing electroless silver or copper plating on the formed pattern to form a metal plating film. More specifically, a manufacturing method described in WO2020/158494A, WO2021/059812A, or WO2021/065226A can be adopted.

A method of forming the first conductive layer 3A and the second conductive layer 3B using a silver halide method will be described. First, by exposing a silver halide emulsion layer including silver halide using an exposure pattern for forming the first conductive layer 3A and the second conductive layer 3B and developing the exposed silver halide layer, the first conductive layer 3A and the second conductive layer 3B can be formed. More specifically, a method of manufacturing the first conductive layer 3A and the second conductive layer 3B described in JP2012-6377A, JP2014-112512A, JP2014-209332A, JP2015-22397A, JP2016-192200A, or WO2016/157585A can be used.

A method of forming the first conductive layer 3A and the second conductive layer 3B using a printing method will be described. First, by applying a conductive paste including conductive powder to a substrate in the same pattern as the first conductive layer 3A and the second conductive layer 3B and heating the conductive paste, the first conductive layer 3A and the second conductive layer 3B can be formed. The pattern formation using the conductive paste is performed, for example, using an ink jet method or a screen printing method. As the conductive paste, more specifically, a conductive paste described in JP2011-28985A can be used.

In addition, the fine metal wire MW is formed as the conductive thin wire using the method of forming the first conductive layer 3A and the second conductive layer 3B.

Basically, the present invention is configured as described above. Hereinabove, the touch sensor film according to the embodiment of the present invention has been described in detail. However, the present invention is not limited to the above-described examples, and various improvements or modifications can be made within a range not departing from the scope of the present invention.

### EXAMPLES

The present invention will be described in more detail based on the following examples. Materials, used amounts, ratios, treatment details, and treatment procedures shown in the following examples can be appropriately changed within a range not departing from the scope of the present invention. Accordingly, the scope of the present invention is not limited to the following examples.

### Example 1

Preparation of Silver Halide Emulsion

The following solution 2 and the following solution 3 were simultaneously added for 20 minutes to the following solution 1 held at pH (hydrogen ion exponent) 4.5 and 38° C. in amounts corresponding to 90% of the entire amounts while stirring the solutions. As a result, nuclear particles having a size of 0.16 μm were formed. Next, the following solution 4 and the following solution 5 were added for 8 minutes, and the remaining 10% amounts of the solution 2 and the solution 3 were further added for 2 minutes. As a result, the nuclear particles grew to a size of 0.21 μm. Further, 0.15 g of potassium iodide was added, and the particles were aged for 5 minutes. Then the formation of the particles was completed.

Solution 1

Water: 750 ml

Gelatin: 8.6 g

Sodium chloride: 3 g

1,3-Dimethylimidazolidine-2-thione: 20 mg

Sodium benzenethiolsulfonate: 10 mg

Citric acid: 0.7 g

Solution 2

Water: 300 ml

Silver nitrate; 150 g

Solution 3

Water: 300 ml

Sodium chloride: 38 g

Potassium bromide: 32 g

Potassium hexachloroiridate(III) (0.005% KCl 20% aqueous solution): 5 ml

Ammonium hexachlororhodate (0.001% NaCl 20% aqueous solution): 7 ml

Solution 4

Water: 100 ml

Silver nitrate: 50 g

Solution 5

Water: 100 ml

Sodium chloride: 13 g

Potassium bromide: 11 g

Yellow prussiate of potash: 5 mg

Next, the particles were cleaned with water by flocculation using an ordinary method. Specifically, the temperature was decreased to 35° C., and the pH was decreased (to be in a range of pH 3.6±0.2) using sulfuric acid until silver halide precipitated. Next, about 3 L of the supernatant liquid was removed (first water cleaning). Further, 3 L of distilled water was added, and sulfuric acid was added until silver halide precipitated. Next, about 3 L of the supernatant liquid was removed again (second water cleaning). By repeating the same operation as the second cleaning once more (third water cleaning), the water cleaning and desalting step was completed. After the water cleaning and desalting, the emulsion was adjusted to pH 6.4 and pAg 7.5, 2.5 g of gelatin, 10 mg of sodium benzenethiolsulfonate, 3 mg of sodium benzenethiosulfinate, 15 mg of sodium thiosulfate, and 10 mg of chloroauric acid were added, and chemosensitization was performed at 55° C. to obtain the optimum sensitivity. Next, 100 mg of 1,3,3a,7-tetraazaindene as a stabilizer and 100 mg of PROXEL (trade name, manufactured by ICI Co., Ltd.) as a preservative were added. The finally obtained emulsion was a silver chloroiodobromide cubic particle emulsion having an average particle diameter of 0.22 μm and a coefficient of variation of 9%, in which the content of silver iodide was 0.08 mol %, and the ratio of silver chlorobromide was 70 mol % of silver chloride/30 mol % of silver bromide.

Preparation of Composition for Forming Photosensitive Layer

1.2×10⁻⁴ mol/mol Ag of 1,3,3a,7-tetraazaindene, 1.2×10⁻² mol/mol Ag of hydroquinone, 3.0×10⁻⁴ mol/mol Ag of citric acid, 0.90 g/mol Ag of 2,4-dichloro-6-hydroxy-1,3,5-triazine sodium salt, and a small amount of a hardening agent were added to the emulsion, and the pH of the coating solution was adjusted to 5.6 using citric acid.

A polymer latex including a polymer represented by (P-1) shown below as an example and a dispersant formed of dialkylphenyl PEO sulfuric acid ester (a mass ratio dispersant/polymer was 2.0/100=0.02) was added to the coating solution such that a mass ratio polymer/gelatin of the polymer to the gelatin in the coating solution was 0.5/1.

Further, EPOXY RESIN DY022 (trade name, manufactured by Nagase ChemteX Corporation) as a crosslinking agent was added. The addition amount of the crosslinking agent was adjusted such that the amount of the crosslinking agent in the silver halide-containing photosensitive layer described below was 0.09 g/m².

This way, the composition for forming a photosensitive layer was prepared.

The polymer represented by (P-1) shown below as an example was synthesized with reference to JP3305459B and JP3754745B.

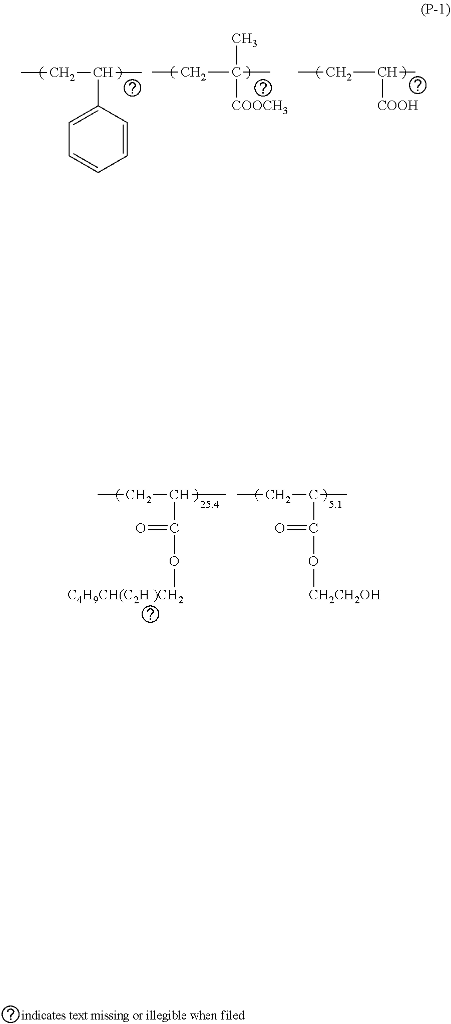

Photosensitive Layer Forming Step

A corona discharge treatment was performed on an insulating substrate, a gelatin layer having a thickness of 0.1 μm as a undercoat layer was provided on opposite surfaces of the insulating substrate, and an antihalation layer including a dye having an optical density of about 1.0 and decolorized by an alkali developer was provided on the undercoat layer. The composition for forming a photosensitive layer was applied to the antihalation layer, and a gelatin layer having a thickness of 0.15 μm was further provided. As a result, an insulating substrate having opposite surfaces on which the photosensitive layer was formed was obtained. An insulating substrate having opposite surfaces on which the photosensitive layer was formed was set as a film A. In the formed photosensitive layer, the silver content was 6.0 g/m², and the gelatin content was 1.0 g/m².

Exposure Development Step

A photomask corresponding to the pattern of the plurality of first detection electrodes 11, the plurality of first lead wires 13, the plurality of first connection terminals, and the plurality of first external connection terminals 14 according to the embodiments shown in FIGS. 2, 3, and 4 was disposed on one surface of the film A, a photomask corresponding to the pattern of the plurality of second detection electrodes 21, the plurality of second lead wires 23, the plurality of second connection terminals, and the plurality of second external connection terminals 24 was disposed on another surface of the film A, and each of both of the surfaces of the film A were exposed using parallel light from a high pressure mercury lamp as a light source. After the exposure, the surfaces of the film A were developed using the following developer and were developed using a fixing solution (trade name: N3X-R for CN16X, manufactured by Fuji Film Co., Ltd.). Further, the film A was rinsed with pure water and was dried. As a result, an insulating substrate having opposite surfaces on which the conductive member formed of Ag wire and the gelatin layer were formed was obtained. The gelatin layer was formed between the Ag wires. The obtained film was set as a film B.

Composition of Developer

1 L of the developer included the following compounds.

Hydroquinone: 0.037 mol/L

N-methylamino phenol: 0.016 mol/L

Sodium metaborate: 0.140 mol/L

Sodium hydroxide: 0.360 mol/L

Sodium bromide: 0.031 mob/L

Potassium metabisulfite: 0.187 mol/L

Gelatin Decomposition Treatment

The film B was dipped in an aqueous solution (concentration of protease: 0.5 mass %, liquid temperature: 40° C.) of protease (BIOPRASE AL-15FG, manufactured by Nagase ChemteX Corporation) for 120 seconds. The film B was taken out from the aqueous solution, was dipped in warm water (liquid temperature: 50° C.) for 120 seconds, and was cleaned. The film having undergone the gelatin decomposition treatment was set as a film C.

Resistance Reducing Treatment

The film C was calendared at a pressure of 30 kN using a calendering device including a metal roller. In this case, two polyethylene terephthalate films having a rough surface shape of line roughness Ra=0.2 μm and Sm=1.9 (measured (JIS-B-0601-1994) using a shape analysis laser microscope VK-X110 manufactured by Keyence Corporation) were transported such that the rough surfaces thereof faced a front surface and a back surface of the film C, and the rough surface shape was formed by transfer on the front surface and the back surface of the film C. After the calendering treatment, the film C was heated by being caused to pass through a superheated steam bath at a temperature of 150° C. for 120 seconds. The heated film was set as a touch sensor film according to Example 1. In the touch sensor film according to Example 1, a plurality of first detection electrodes, a plurality of first lead wires, and a plurality of first external connection terminals were formed on a first surface of the insulating substrate, and a plurality of second detection electrodes, a plurality of second lead wires, and a plurality of second external connection terminals were formed on a second surface of the insulating substrate.

In this case, the detection electrode had a rhombic mesh-like shape, the length of the fine metal wire from an intersection to an adjacent intersection in the rhombic mesh-like shape was 400 μm, the angle between directions in which the fine metal wire and the detection electrode extend was 59°, the line width of the fine metal wires MW forming the detection electrode was 1.8 μm, and the line width of the lead wire was 5 μm. In addition, the line width of the first connection terminal 401 was 5 μm, the length L41 was the same as the width of the detection electrode, the line width of the second connection terminal 402 was 5 μm, the length L42 was the same as the width of the detection electrode, and the interval P4 between the first connection terminal 401 and the second connection terminal 402 was 100 μm.

### Example 2

A touch sensor according to Example 2 was manufactured using the same method as that of Example 1, except that a photomask was changed such that the line width of the first connection terminal 401 was 1.8 μm, the length L41 was the same as the width of the detection electrode, the line width of the second connection terminal 402 was 1.8 μm, the length L42 was the same as the width of the detection electrode, and the interval P4 between the first connection terminal 401 and the second connection terminal 402 was 100 μm.

### Example 3

A touch sensor according to Example 3 was manufactured using the same method as that of Example 1, except that a photomask was changed such that the line width of the first connection terminal 401 was 5 μm, the length L41 was the same as the width of the detection electrode, the line width of the second connection terminal 402 was 5 μm, the length L42 was the same as the width of the detection electrode, and the interval P4 between the first connection terminal 401 and the second connection terminal 402 was 20 μm.

### Example 4

A touch sensor according to Example 4 was manufactured using the same method as that of Example 1, except that a photomask was changed such that the line width of the first connection terminal 401 was 1.8 μm, the length L41 was the same as the width of the detection electrode, the line width of the second connection terminal 402 was 1.8 μm, the length L42 was the same as the width of the detection electrode, and the interval P4 between the first connection terminal 401 and the second connection terminal 402 was 20 μm.

### Example 5

A touch sensor according to Example 5 was manufactured using the same method as that of Example 1, except that a photomask was changed such that the line width of the first connection terminal 401 was 5 μm, the length L41 was the same as the width of the detection electrode, the line width of the second connection terminal 402 was 5 μm, the length L42 was the same as the width of the detection electrode, and the interval P4 between the first connection terminal 401 and the second connection terminal 402 was 4 μm.

### Example 6

A touch sensor according to Example 6 was manufactured using the same method as that of Example 1, except that a photomask was changed such that the line width of the first connection terminal 401 was 1.8 μm, the length L41 was the same as the width of the detection electrode, the line width of the second connection terminal 402 was 1.8 μm, the length L42 was the same as the width of the detection electrode, and the interval P4 between the first connection terminal 401 and the second connection terminal 402 was 4 μm.

### Example 7

A touch sensor according to Example 7 was manufactured using the same method as that of Example 1, except that a photomask was changed such that the line width of the fine metal wires MW forming the detection electrode was 3.5 μm, the line width of the lead wire was 20 μm, the line width of the first connection terminal 401 was 5 μm, the length L41 was the same as the width of the detection electrode, the line width of the second connection terminal 402 was 5 μm, the length L42 was the same as the width of the detection electrode, and the interval P4 between the first connection terminal 401 and the second connection terminal 402 was 100 μm.

### Example 8

A touch sensor according to Example 8 was manufactured using the same method as that of Example 7, except that a photomask was changed such that the line width of the first connection terminal 401 was 3.5 μm, the length L41 was the same as the width of the detection electrode, the line width of the second connection terminal 402 was 3.5 μm, the length L42 was the same as the width of the detection electrode, and the interval P4 between the first connection terminal 401 and the second connection terminal 402 was 100 μm.

### Example 9

A touch sensor according to Example 9 was manufactured using the same method as that of Example 1, except that a photomask was changed such that the shape was changed as shown in FIG. 5, the line width of the fine metal wires MW forming the detection electrode was 1.8 μm, the line width of the lead wire was 5 μm, the line width of the first connection terminal 501 was 5 μm, the length L51 was the same as the width of the detection electrode, the line width of the second connection terminal 502 was 5 μm, the length L52 was the same as the width of the detection electrode, the line width of the third connection terminal 503 was 5 μm, the length L53 was the same as the width of the detection electrode, the interval P51 between the first connection terminal 501 and the second connection terminal 502 was 20 μm, and the interval P52 between the second connection terminal 502 and the third connection terminal 503 was 50 μm.

### Example 10

A touch sensor according to Example 10 was manufactured using the same method as that of Example 9, except that a photomask was changed such that the line width of the first connection terminal 501 was 1.8 μm, the length L51 was the same as the width of the detection electrode, the line width of the second connection terminal 502 was 1.8 μm, the length L52 was the same as the width of the detection electrode, the line width of the third connection terminal 503 was 1.8 μm, the length L53 was the same as the width of the detection electrode, the interval P51 between the first connection terminal 501 and the second connection terminal 502 was 20 μm, and the interval P52 between the second connection terminal 502 and the third connection terminal 503 was 50 μm.

### Example 11

A touch sensor according to Example 11 was manufactured using the same method as that of Example 9, except that a photomask was changed such that the line width of the first connection terminal 501 was 5 μm, the length L51 was the same as the width of the detection electrode, the line width of the second connection terminal 502 was 5 μm, the length L52 was the same as the width of the detection electrode, the line width of the third connection terminal 503 was 5 μm, the length L53 was the same as the width of the detection electrode, the interval P51 between the first connection terminal 501 and the second connection terminal 502 was 100 μm, and the interval P52 between the second connection terminal 502 and the third connection terminal 503 was 100 μm.

### Example 12

A touch sensor according to Example 12 was manufactured using the same method as that of Example 9, except that a photomask was changed such that the line width of the first connection terminal 501 was 1.8 μm, the length L51 was the same as the width of the detection electrode, the line width of the second connection terminal 502 was 1.8 μm, the length L52 was the same as the width of the detection electrode, the line width of the third connection terminal 503 was 1.8 μm, the length L53 was the same as the width of the detection electrode, the interval P51 between the first connection terminal 501 and the second connection terminal 502 was 100 μm, and the interval P52 between the second connection terminal 502 and the third connection terminal 503 was 100 μm.

### Example 13

A touch sensor according to Example 13 was manufactured using the same method as that of Example 1, except that a photomask was changed such that the shape was changed as shown in FIG. 4, the line width of the first connection terminal 401 was 5 μm, the length L41 was twice the width of the detection electrode, the line width of the second connection terminal 402 was 5 μm, the length L42 was the same as the width of the detection electrode, and the interval P4 between the first connection terminal 401 and the second connection terminal 402 was 100 μm.

### Example 14

A touch sensor according to Example 14 was manufactured using the same method as that of Example 1, except that a photomask was changed such that the line width of the first connection terminal 401 was 1.8 μm, the length L41 was twice the width of the detection electrode, the line width of the second connection terminal 402 was 1.8 μm, the length L42 was the same as the width of the detection electrode, and the interval P4 between the first connection terminal 401 and the second connection terminal 402 was 100 μm.

### Example 15

A touch sensor according to Example 15 was manufactured using the same method as that of Example 1, except that a photomask was changed such that the line width of the first connection terminal 401 was 5 μm, the length L41 was twice the width of the detection electrode, the line width of the second connection terminal 402 was 5 μm, the length L42 was twice the width of the detection electrode, and the interval P4 between the first connection terminal 401 and the second connection terminal 402 was 100 μm.

### Example 16

A touch sensor according to Example 16 was manufactured using the same method as that of Example 1, except that a photomask was changed such that the line width of the first connection terminal 401 was 1.8 μm, the length L41 was twice the width of the detection electrode, the line width of the second connection terminal 402 was 1.8 μm, the length L42 was twice the width of the detection electrode, and the interval P4 between the first connection terminal 401 and the second connection terminal 402 was 100 μm.

### Example 17

A touch sensor according to Example 17 was manufactured using the same method as that of Example 1, except that a photomask was changed such that the shape was changed as shown in FIG. 7, the line width of the first connection terminal 401 was 5 μm, the length L41 was the same as the width of the detection electrode, the line width of the second connection terminal 402 was 5 μm, the length L42 was 0.6 times the width of the detection electrode, and the interval P4 between the first connection terminal 401 and the second connection terminal 402 was 20 μm.

### Example 18

A touch sensor according to Example 18 was manufactured using the same method as that of Example 1, except that a photomask was changed such that the shape was changed as shown in FIG. 7, the line width of the first connection terminal 401 was 1.8 μm, the length L41 was the same as the width of the detection electrode, the line width of the second connection terminal 402 was 1.8 μm, the length L42 was 0.6 times the width of the detection electrode, and the interval P4 between the first connection terminal 401 and the second connection terminal 402 was 20 μm.

### Example 19

A touch sensor according to Example 19 was manufactured using the same method as that of Example 1, except that a photomask was changed such that the shape was changed as shown in FIG. 8, the line width of the first connection terminal 401 was 5 μm, the length L41 was twice the width of the detection electrode, the line width of the second connection terminal 402 was 5 μm, the length L42 was 0.6 times the width of the detection electrode, and the interval P4 between the first connection terminal 401 and the second connection terminal 402 was 20 μm.

### Example 20

A touch sensor according to Example 20 was manufactured using the same method as that of Example 1, except that a photomask was changed such that the shape was changed as shown in FIG. 8, the line width of the first connection terminal 401 was 1.8 μm, the length L41 was third times the width of the detection electrode, the line width of the second connection terminal 402 was 1.8 μm, the length L42 was 0.6 times the width of the detection electrode, and the interval P4 between the first connection terminal 401 and the second connection terminal 402 was 20 μm.

### Example 21

A touch sensor according to Example 21 was manufactured using the same method as that of Example 1, except that a photomask was changed such that the line width of the first connection terminal 401 was 5 μm, the length L41 was the same as the width of the detection electrode, the line width of the second connection terminal 402 was 5 μm, the length L42 was the same as the width of the detection electrode, and the interval P4 between the first connection terminal 401 and the second connection terminal 402 was 5 μm.

### Example 22

A touch sensor according to Example 22 was manufactured using the same method as that of Example 1, except that a photomask was changed such that the line width of the first connection terminal 401 was 1.8 μm, the length L41 was the same as the width of the detection electrode, the line width of the second connection terminal 402 was 1.8 μm, the length L42 was the same as the width of the detection electrode, and the interval P4 between the first connection terminal 401 and the second connection terminal 402 was 5 μm.

### Comparative Example 1

A touch sensor according to Comparative Example 1 was manufactured using the same method as that of Example 1, except that a photomask was changed such that the shape was changed as shown in FIG. 3, the line width of the detection electrode was 1.8 μm, the line width of the lead wire was 5 μm, the line width of a connection terminal 301 was 5 μm, and the length L3 was the same as the width of the detection electrode.

### Comparative Example 2

A touch sensor according to Comparative Example 2 was manufactured using the same method as that of Comparative Example 1, except that a photomask was changed such that the line width of the connection terminal 301 was 1.8 μm and the length L3 was the same as the width of the detection electrode.

### Comparative Example 3

A touch sensor according to Comparative Example 3 was manufactured using the same method as that of Comparative Example 1, except that a photomask was changed such that the line width of the detection electrode was 3.5 μm, the line width of the lead wire was 20 μm, the line width of the connection terminal 301 was 20 μm, and the length L3 was the same as the width of the detection electrode.

### Comparative Example 4

A touch sensor according to Comparative Example 4 was manufactured using the same method as that of Comparative Example 3, except that a photomask was changed such that the line width of the connection terminal 301 was 3.5 μm and the length L3 was the same as the width of the detection electrode.

For the touch sensors according to Examples 1 to 22 and Comparative Examples 1 to 4 obtained as described above, the following conduction evaluation was performed.

In Examples 1 to 22 and Comparative Examples 1 to 4, the line width of the detection electrode, the line width of the lead wire, and the line width and the interval of the connection terminal were measured using the above-described method of measuring the line width and the interval.

Conduction Evaluation

200 touch sensor films were laminated and were left to stand for 1 day in this state. Next, the touch sensor films were taken out one by one, a resistance value between an end part of the first detection electrode and the first external connection terminal and a resistance value between an end part of the second detection electrode and the second external connection terminal were measured. In this case, a touch sensor including one portion where the resistance value was not able to be measured (was overloaded) was determined as a touch sensor having a conduction failure, and a ratio of the number of the touch sensors having a conduction failure to all of the 200 touch sensors was calculated as a failure incidence ratio. In this case, in a case where the failure incidence ratio was 0.5% or less, it was determined that a sufficient manufacturing efficiency was obtained. The above-described failure incidence ratio is the spark failure incidence ratio. The above-described failure incidence ratio was shown in “Spark Failure Incidence Ratio” of Table 1 below.

Table 1 below shows the results of the conduction evaluation for Examples 1 to 22 and Comparative Examples 1 to 4.

TABLE 1

| | | | | | | | Interval between |
|---|---|---|---|---|---|---|---|
| | Detection | | | Line Width [μm] | | | Connection Terminals [μm] |
| | Electrode | Lead Wire | | Connection | Connection | | Connection |
| | Line Width | Line Width | Reference | Terminal X01 | Terminal X02 | Connection | Terminals X01-X02: P4, P51 |
| | [μm] | [μm] | Diagram | (X = 3, 4, or 5) | (X = 4 or 5) | Terminal 503 | (X = 4 or 5) |
| Comparative | 1.8 | 5 | FIG. 3 | 5 | — | — | — |
| Example 1 | | | | | | | |
| Comparative | 1.8 | 5 | FIG. 3 | 1.8 | — | — | — |
| Example 2 | | | | | | | |
| Comparative | 3.5 | 20 | FIG. 3 | 20 | — | — | — |
| Example 3 | | | | | | | |
| Comparative | 3.5 | 20 | FIG. 3 | 3.5 | — | — | — |
| Example 4 | | | | | | | |
| Example 1 | 1.8 | 5 | FIG. 4 | 5 | 5 | — | 100 |
| Example 2 | 1.8 | 5 | FIG. 4 | 1.8 | 1.8 | — | 100 |
| Example 3 | 1.8 | 5 | FIG. 4 | 5 | 5 | — | 20 |
| Example 4 | 1.8 | 5 | FIG. 4 | 1.8 | 1.8 | — | 20 |
| Example 5 | 1.8 | 5 | FIG. 4 | 5 | 5 | — | 4 |
| Example 6 | 1.8 | 5 | FIG. 4 | 1.8 | 1.8 | — | 4 |
| Example 7 | 3.5 | 20 | FIG. 4 | 5 | 5 | — | 100 |
| Example 8 | 3.5 | 20 | FIG. 4 | 3.5 | 3.5 | — | 100 |
| Example 9 | 1.8 | 5 | FIG. 5 | 5 | 5 | 5 | 20 |
| Example 10 | 1.8 | 5 | FIG. 5 | 1.8 | 1.8 | 1.8 | 20 |
| Example 11 | 1.8 | 5 | FIG. 5 | 5 | 5 | 5 | 100 |
| Example 12 | 1.8 | 5 | FIG. 5 | 1.8 | 1.8 | 1.8 | 100 |
| Example 13 | 1.8 | 5 | FIG. 4 | 5 | 5 | — | 100 |
| Example 14 | 1.8 | 5 | FIG. 4 | 1.8 | 1.8 | — | 100 |
| Example 15 | 1.8 | 5 | FIG. 4 | 5 | 5 | — | 100 |
| Example 16 | 1.8 | 5 | FIG. 4 | 1.8 | 1.8 | — | 100 |
| Example 17 | 1.8 | 5 | FIG. 7 | 5 | 5 | — | 20 |
| Example 18 | 1.8 | 5 | FIG. 7 | 1.8 | 1.8 | — | 20 |
| Example 19 | 1.8 | 5 | FIG. 8 | 5 | 5 | — | 20 |
| Example 20 | 1.8 | 5 | FIG. 8 | 1.8 | 1.8 | — | 20 |
| Example 21 | 1.8 | 5 | FIG. 4 | 5 | 5 | — | 5 |
| Example 22 | 1.8 | 5 | FIG. 4 | 1.8 | 1.8 | — | 5 |

| | Interval between | | | | |
|---|---|---|---|---|---|
| | Connection Terminals [μm] | | | | Spark |
| | Connection | Connection | Connection | | Failure |
| | Terminals 502-503: | Terminal X01 | Terminal X02 | Connection | Incidence |
| | P52 | (X = 3, 4, or 5) | (X = 4 or 5) | Terminal 503 | Ratio |
| Comparative | — | 1 | — | — | 12.0% |
| Example 1 | | | | | |
| Comparative | — | 1 | — | — | 11.1% |
| Example 2 | | | | | |
| Comparative | — | 1 | — | — | 10.5% |
| Example 3 | | | | | |
| Comparative | — | 1 | — | — | 9.9% |
| Example 4 | | | | | |
| Example 1 | — | 1 | 1 | — | 2.5% |
| Example 2 | — | 1 | 1 | — | 1.2% |
| Example 3 | — | 1 | 1 | — | 2.6% |
| Example 4 | — | 1 | 1 | — | 1.1% |
| Example 5 | — | 1 | 1 | — | 6.2% |
| Example 6 | — | 1 | 1 | — | 5.3% |
| Example 7 | — | 1 | 1 | — | 2.2% |
| Example 8 | — | 1 | 1 | — | 1.0% |
| Example 9 | 50 | 1 | 1 | 1 | 1.8% |
| Example 10 | 50 | 1 | 1 | 1 | 0.9% |
| Example 11 | 100 | 1 | 1 | 1 | 1.7% |
| Example 12 | 100 | 1 | 1 | 1 | 1.0% |
| Example 13 | — | 2 | 1 | — | 1.6% |
| Example 14 | — | 2 | 1 | — | 0.5% |
| Example 15 | — | 2 | 2 | — | 1.5% |
| Example 16 | — | 2 | 2 | — | 0.6% |
| Example 17 | — | 1 | 0.6 | — | 2.6% |
| Example 18 | — | 1 | 0.6 | — | 1.1% |
| Example 19 | — | 2 | 0.6 | — | 1.6% |
| Example 20 | — | 3 | 0.6 | — | 0.5% |
| Example 21 | — | 1 | 1 | — | 2.0% |
| Example 22 | — | 1 | 1 | — | 1.5% |

As shown in Table 1, in Examples 1 to 22 according to the present invention, the conduction failure incidence ratio was low, and an excellent manufacturing efficiency was obtained as compared to Comparative Examples 1 to 4. In addition, it can be seen from comparisons between Examples 1 and 2, Examples 3 and 4, Examples 5 and 6. Examples 7 and 8, Examples 9 and 10, Examples 11 and 12, Examples 13 and 14, Examples 15 and 16, Examples 17 and 18, Examples 19 and 20, and Examples 21 and 22 that, since the line width of the connection terminal was the same as the conductive thin wire of the detection electrode, the conduction failure incidence ratio was low. That is, the spark failure incidence ratio further decreased. The reason for this is presumed to be that, since the area between wiring lines during contact of two surfaces was small, the amount of peeling charge was small. In addition, it can be seen from comparisons between Examples 1 to 6 that, since the interval of the connection terminal between the connection terminals was 5 μm or more, the conduction failure incidence ratio was able to be further reduced. That is, the spark failure incidence ratio further decreased. The reason for this is presumed to be that, by increasing the distance between contact portions where peeling charging ma occur, the current density generated by peeling charging can be reduced.

In addition, it can be seen from comparisons between Examples 5, 6, 21, and 22 that, in a case where the interval between the connection terminals was 5 μm or more, the spark failure incidence ratio further decreased. The reason for this is also presumed to be that, by increasing the distance between contact portions where peeling charging ma occur, the current density generated by peeling charging can be reduced.

### EXPLANATION OF REFERENCES

1: touch sensor film
2: substrate
2A: first surface
2B: second surface
3A: first conductive layer
3B: second conductive layer
11: first detection electrode
13: first lead wire
14: first external connection terminal
15, 25: wiring part
16, 26: connection terminal
301, 401, 501, 60-1: first connection terminal
402, 502, 60-n: second connection terminal
503, 60-2 to (n−1): third connection terminal
21: second detection electrode
23: second lead wire
24: second external connection terminal
MP: pattern
MW: fine metal wire
Q1: first electrode region
Q2: second electrode region
L3, L41, L42, L51, L52, L53, L60-1 to n: length of connection terminal
P3, P41, P42, P1, P52, P60-1 to (n−1); interval between connection terminals
W: width of detection electrode

What is claimed is:

1. A touch sensor film comprising:
a plurality of detection electrodes; and
a plurality of lead wires that are electrically connected to the plurality of detection electrodes,
wherein each of the plurality of detection electrodes has a mesh structure formed of a conductive thin wire,
each of the plurality of detection electrodes includes a first connection terminal disposed at an outermost side of each of the plurality of detection electrodes and a second connection terminal disposed by spacing from the first connection terminal, and
each of the plurality of lead wires extends up to the second connection terminal through the first connection terminal and electrically connect the first connection terminal and the second connection terminal to each other.

2. The touch sensor film according to claim 1,
wherein line widths of the first connection terminal and the second connection terminal are the same as a line width of the conductive thin wire.

3. The touch sensor film according to claim 1,
wherein each of the plurality of detection electrodes further includes a third connection terminal that is electrically connected to each of the plurality of lead wires, and
the first connection terminal, the second connection terminal, and the third connection terminal are disposed in this order.

4. The touch sensor film according to claim 2,
wherein each of the plurality of detection electrodes further includes a third connection terminal that is electrically connected to each of the plurality of lead wires, and
the first connection terminal, the second connection terminal, and the third connection terminal are disposed in this order.

5. The touch sensor film according to claim 1,
wherein a length of any one of the first connection terminal or the second connection terminal is more than an electrode width of each of the plurality of detection electrodes.

6. The touch sensor film according to claim 2,
wherein a length of any one of the first connection terminal or the second connection terminal is more than an electrode width of each of the plurality of detection electrodes.

7. The touch sensor film according to claim 1,
wherein an interval between the at least two connection terminals is 5 μm or more.
